(19) United States
(12) Patent Application Publication
(10) Pub. No.: US 2019/0379841 A1
(43) Pub. Date: Dec. 12, 2019

(54) APPARATUS AND METHOD FOR DISPLAYING INFORMATION

(71) Applicant: JAGUAR LAND ROVER LIMITED, COVENTRY, WARWICKSHIRE (GB)

(72) Inventors: Robert Hardy, Warwickshire (GB); Philip Thomas, Warwickshire (GB); David Wilson, Warwickshire (GB); Martin Edney, Warwickshire (GB)

(21) Appl. No.: 16/486,267

(22) PCT Filed: Jan. 29, 2018
(86) PCT No.: PCT/EP2018/052085

§ 371 Date: Aug. 15, 2019

(30) Foreign Application Priority Data
Feb. 16, 2017 (GB) 1702536.2

(51) Int. Cl. H04N 5/265; G06T 7/70; B60R 1/00; B60K 35/00

(52) U.S. Cl. CPC H04N 5/265; G06T 7/70; B60R 1/00; B60K 35/00; B60R 2300/105; G06T 2207/30252; B60R 2300/304; B60R 2300/307; B60K 2370/167; G06T 2207/10016

(57) ABSTRACT

Embodiments of the present invention provide display method for use in a vehicle, the method comprising: obtaining (600) images of a region external to the vehicle; storing (608) at least a portion of the obtained images; generating (614) a composite image from a current image and a stored image by matching (612) portions of the stored image and the current image; and displaying (616) at least part of the composite image; wherein the composite image comprises a first region generated from the current image and a second region generated from the stored image, the second region not being visible within the current image.

### TECHNICAL FIELD

The present invention relates to an apparatus and method for displaying information. Particularly, but not exclusively, the present invention relates to a display method for use in a vehicle and a display apparatus for use in a vehicle. Aspects of the invention relate to a display method, a computer program product, a display apparatus and a vehicle.

### BACKGROUND

It is important for a driver of a vehicle to be provided with information to drive the vehicle safely and accurately. Information provided to the driver includes a view from the vehicle, in particular, ahead or forward of the vehicle, and also information concerning the vehicle such as a speed of the vehicle. In some vehicles, such as sports utility vehicles (SUVs) or 4 wheel drive vehicles, the view ahead of the vehicle is partially obscured by a bonnet or hood of the vehicle, particularly a region a short distance ahead of the vehicle. This can be exacerbated by the vehicle being on an incline, on a crest, or at a top of a descent, such as when driving off-road. Furthermore, especially when driving off-road, while obstacles and objects such as rocks may be viewed ahead of a vehicle before they are reached, once the vehicle is positioned over an object it can be difficult to ascertain where the vehicle is in relation to that object. Specifically, it can be hard to ascertain where the object is in relation to portions of the vehicle, for instance the wheels. More broadly, objects close to a vehicle, without being directly underneath the vehicle, can be hard to see from the driver's position. Correct positioning of a vehicle relative to an object can be important to avoid the risk of damage to the vehicle.

It is an object of embodiments of the invention to at least mitigate one or more of the problems of the prior art. It is an object of certain embodiments of the invention to aid a driver of a vehicle. It is an object of embodiments of the invention to improve a driver's understanding of the environment surrounding a vehicle including underneath the vehicle.

### SUMMARY OF THE INVENTION

Aspects and embodiments of the invention provide a display method, a computer program product, a display apparatus and a vehicle as claimed in the appended claims.

According to an aspect of the invention, there is provided a display method for use in a vehicle, the method comprising: capturing images of a region external to the vehicle; storing at least a portion of the captured images; generating a composite image from a current image and a stored image by matching portions of the stored image and the current image; and displaying at least part of the composite image; wherein the composite image comprises a first region generated from the current image and a second region generated from the stored image, the second region not being visible within the current image.

The composite image may comprise a 3-Dimensional, 3D, representation or a 2-Dimensional, 2D, representation of the environment surrounding the vehicle and extending at least partially underneath the vehicle.

Displaying at least part of the composite image may comprise generating a 2D representation of at least a portion of the 3D representation and displaying the 2D representation.

The image data may comprise a series of image frames; and wherein the method may further comprise: determining a position of the vehicle; and storing an indication of the position of the vehicle with at least a portion of an image frame.

Matching portions of the stored image and the current image may comprise matching overlapping portions of the stored image and the current image.

Matching portions of the stored image and the current image may comprise performing pattern matching to identify features present in both the stored image and the current image such those features are correlated in the composite image.

The display method may further comprise determining a pattern recognition region including an area which is not visible within the current image; and determining a stored image including image data for the environment within the pattern recognition area.

Determining a pattern recognition region may comprise determining coordinates for the pattern recognition region according to a current position of the vehicle.

Determining a pattern recognition region may further include receiving a signal indicating an orientation of the vehicle and adjusting the pattern recognition region coordinates according to the vehicle orientation.

Storing at least a portion of the captured image may comprise: storing a first obtained image frame; determining a degree of overlap between the first obtained image frame and a second obtained image frame; and for the second obtained image frame storing a non-overlapping portion of the second image frame.

The composite image may include image data from multiple current images representing different views from the vehicle and at least one stored image such that the composite image comprises a contiguous view of at least a portion of the environment surrounding the vehicle and extending underneath the vehicle.

The display method may further comprise obtaining information associated with the vehicle and displaying a graphical representation of at least one component of the vehicle within the composite image.

The information associated with the vehicle may be information associated with the at least one component of the vehicle, the at least one component of the vehicle comprising at least one of: a steering system of the vehicle; one or more wheels of the vehicle; a suspension of the vehicle or an engine of the vehicle; or a further mechanical component of the vehicle.

The composite image may be displayed to overlie a portion of the vehicle to be indicative of a portion of the vehicle being at least partly transparent.

The composite image may be displayed to be translucent or overly an internal or external vehicle portion.

The image data may be obtained from one or more cameras associated with the vehicle and arranged to capture images of the environment surrounding the vehicle.

According to a further aspect of the invention, there is provided a computer program product storing computer program code which is arranged when executed to implement the above method.

According to a further aspect of the invention, there is provided a display apparatus for use with a vehicle, comprising: image capturing apparatus arranged to obtain images of a region external to the vehicle; a display arranged to display information; a storage means arranged to store at least a portion of the obtained images; a processing means arranged to: receive a current image from the image capturing apparatus; cause the storage means to store at least a portion of the obtained images; generate a composite image from a current image and a stored image by matching portions of stored image and current image; and cause the display to display at least part of the composite image; wherein the composite image comprises a first region generated from the current image and a second region generated from the stored image, the second region not being visible within the current image.

A display apparatus as described above, wherein the image capturing apparatus comprises a camera or other form of image capture device arranged to generate and output still images or moving images. The display may comprise a display screen, for instance a LCD display screen suitable for installation in a vehicle. Alternatively, the display may comprise a projector for forming a projected image. The processing means may comprise a controller or processor, suitably the vehicle ECU.

The processing means may be further arranged to implement the above method.

According to a further aspect of the invention, there is provided a vehicle comprising the above display apparatus.

According to a further aspect of the invention, there is provided a display method, a display apparatus or a vehicle substantially as herein described with reference to FIGS. 9, 10 and 3 respectively of the accompanying drawings.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described by way of example only, with reference to the accompanying figures, in which:

FIG. 1 shows an illustration of a typical view from a conventional vehicle;

FIG. 2 shows an illustration of an improved view from a vehicle;

FIG. 3 illustrates a portion of a vehicle operating to provide the improved view of FIG. 2;

FIG. 4 illustrates a composite 3D image derived from vehicle mounted cameras;

FIG. 5 illustrates a composite 2D image, specifically a bird's eye view, derived from vehicle mounted cameras;

FIG. 6 illustrates a method according to an embodiment of the invention for providing a composite image;

FIG. 7 illustrates a composite 2D image, specifically a bird's eye view, tracking a moving vehicle according to an embodiment of the invention; and

FIG. 8 illustrates an apparatus according to an embodiment of the invention for implementing the method of FIG. 6.

### DETAILED DESCRIPTION

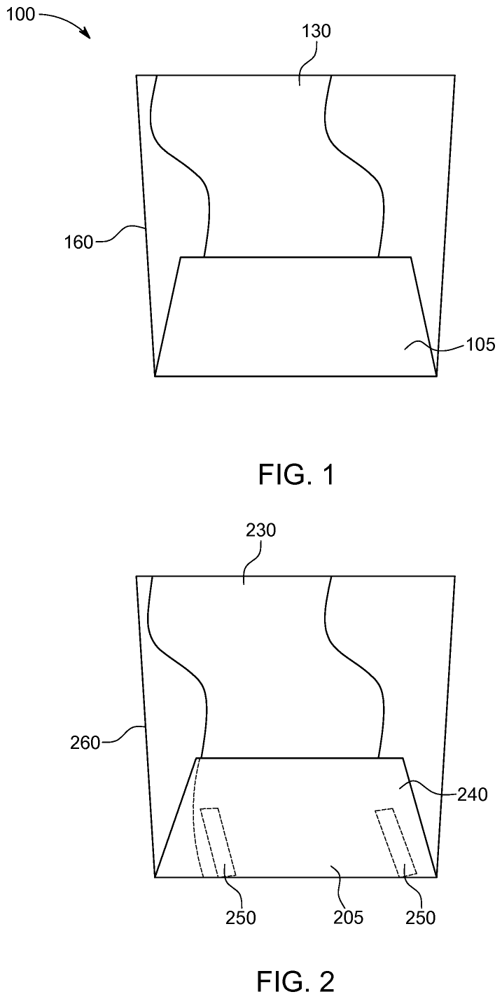

FIG. 1 illustrates a typical view 100 from a conventional vehicle. The view is from an interior of the vehicle through a windscreen or windshield 160 of the vehicle viewing forwards. A portion of a bonnet or hood 105 of the vehicle is visible extending forward from beneath the windscreen 160. The vehicle is travelling along a roadway 130 which is visible from the vehicle. As can be appreciated, the bonnet 105 obscures the view of the roadway 130 close the vehicle. This problem is exacerbated when the vehicle is inclined with respect to the roadway 130 ahead of the vehicle i.e. when an angle between the vehicle and the roadway ahead is increased, such as when the vehicle is approaching a crest or at a top of a descent (and not yet descending a slope) or is inclined upward on a small undulation or towards the top of an ascent. In these situations the roadway 130 may have reduce visibility from the vehicle particularly due to being obscured by the bonnet 105. It will be appreciated that the aforementioned problem may be relatively minor in normal on-road driving, but in more challenging off-road driving, this problem can greatly diminish the driver's confidence in making safe progress across difficult terrain.

More generally, it may be considered that from the viewing position of the driver the view of the roadway 130 ahead is partially occluded both by external portions of the vehicle (especially the bonnet 105) and internal portions of the vehicle, for instance the bodywork surrounding the windscreen 160 and the dashboard. In the following description of the invention, where reference is made to the view of the driver or from the driver's position, this should be considered to encompass the view of a passenger, though clearly for manually driven vehicles it is the driver's view that is of paramount importance. In particular, it is portions of the roadway 130 close to the front of the vehicle that are occluded. It will be appreciated that the driver's view of the environment surrounding the vehicle on all sides is similarly restricted by the field of view available through each vehicle window from the driver's viewing position. In general, a driver is unable to see portions of the environment close to the vehicle due to restrictions imposed by vehicle bodywork.

Of course, a well-known partial solution to this problem is the use of mirrors, especially wing mirrors or side mirrors mounted on the exterior of the vehicle which provide an improved view of the environment close to the sides of the vehicle as well as of the blind-spots generally behind and to the side of the vehicle. However, it remains the case that for conventional vehicles the view for the driver of the environment and terrain immediately surrounding the vehicle can be very limited. Furthermore, there is no view at all of the terrain immediately underneath the vehicle. Particularly when driving a vehicle off-road it can be important to appreciate the alignment of the vehicle relative to objects, for instance rocks, both surrounding and underneath the vehicle in order to avoid vehicle damage. Conventionally, this can only be done by the driver remembering the terrain as the vehicle drives forward and visualising where the vehicle must be relative to objects as they disappear from the driver's field of view, and in particular pass under the vehicle, or by the driver exiting the vehicle and inspecting its position relative to objects that may pose a threat. Clearly this requires skill and practice on the part of the driver, and even then is inexact.

It is becoming commonplace for vehicles to be provided with one or more video cameras to provide live video images (or still images) of the environment surrounding a vehicle. Such images may then be displayed for the benefit of the driver, for instance on a dashboard mounted display screen. In particular, it is well-known to provide a camera system with at least one camera towards the rear of the vehicle directed generally behind the vehicle and downwards to provide live video images to assist a driver who is reversing (it being the case that the driver's natural view of the environment immediately behind the vehicle is particularly limited). It is known to provide multiple such camera systems to provide live imagery of the environment surrounding the vehicle on multiple sides, for instance displayed on a dashboard mounted display screen. For instance, a driver may selectively display different camera views in order to ascertain the locations of objects close to each side of the vehicle. Such cameras may be positioned externally mounted upon the vehicle, or internally and directed outwards and downwards through the vehicle glass in order to capture images.

Such cameras may be provided at varying heights relative to the ground on which the vehicle is standing, for instance generally at roof level, driver's eye level or some suitable lower location to avoid vehicle bodywork obscuring their view of the environment immediately adjacent to the vehicle. However, while being a significant improvement over a driver's natural field of view, such camera systems are of no assistance for determining the location of objects underneath the vehicle. It might be considered that the solution to this inability to view the terrain underneath a vehicle is to position one or more cameras underneath the vehicle or to the side of the vehicle and directed underneath the vehicle. However, the underneath of a vehicle is not a promising area for image capture due to it being poorly lit. Furthermore, cameras located generally underneath a vehicle are exposed to a significant risk of damage due to contact with objects such as rocks.

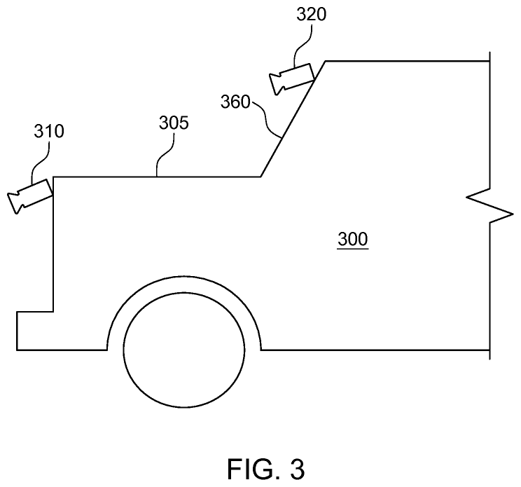

One solution to the above described problem of poor visualisation of the roadway ahead of a vehicle will now be described in relation to FIGS. 2 and 3. The vehicle may be a land-going vehicle, such as a wheeled vehicle. FIG. 2 illustrates an improved forward view 200. The view 200 is from an interior of the vehicle forwards through a windscreen or windshield 260 of the vehicle, as in FIG. 1. A portion of a bonnet or hood 205 of the vehicle is visible extending forward from beneath the windscreen 260. The vehicle is travelling along a track or roadway 230, a portion of which is visible from within the vehicle through the windshield 260.

The vehicle shown in FIG. 2 comprises a display means which is arranged to display information 240, 250 thereon. The information 240, 250 is displayed so as to overlie a portion of the vehicle. The overlaid displayed information provides the impression of a portion of the vehicle being at least partly transparent from the perspective of the driver. The displayed information provides a representation of what would be visible along a line of sight through the vehicle, were it not for the fact that a portion of the vehicle is occluding that line of sight.

As shown in FIG. 2, the information 240, 250 is displayed to overlie a portion of the vehicle's body, in this case the bonnet 205 of the vehicle. It will be realised that by extension information 240, 250 may be displayed to overlie other internal or external portions of the vehicle. The information 240, 250 is arranged to overlie the bonnet 205 of the vehicle from a point of view of the driver of the vehicle. The display means may be arranged to translucently display information 240, 250 thereon such that the portion of the vehicle body may still be perceived, at least faintly, underneath the displayed information. This can be particularly helpful to new users unfamiliar with the system and help them understand the information being presented on the display means.

The display means may comprise a head-up display means for displaying information in a head-up manner to at least the driver of the vehicle. The head-up display may form part of, consist of or be arranged proximal to the windscreen 260 such that the information 240, 250 is displayed to overlie the bonnet 205 of the vehicle. By overlie it is meant that the displayed information 240, 250 appears upon (or in front of) the bonnet 205. Where images of other portions of the environment surrounding the vehicle are to be displayed, the head-up display may be similarly arranged relative to another window of the vehicle. An alternative is for the display means to comprise a projection means. The projection means may be arranged to project an image onto an interior portion of the vehicle, such as onto a dashboard, door interior, or other interior components of the vehicle. The projection means may comprise a laser device for projecting the image onto the vehicle interior.

A method of providing the improved view of FIG. 2 begins with obtaining information associated with the vehicle, or image data. The information or image data may be obtained by a processing means, such as a processing device. The information associated with the vehicle may for instance be associated with one of a steering system of the vehicle, one or more wheels of the vehicle or suspension of the vehicle. In the described example the information is a steering angle of the wheels. The information may be obtained by the processing device from one or more steering angle sensors. The information may be obtained by the processing device receiving information from a communication bus of the vehicle, such as a CAN bus, although the communication bus may be based on other protocols such as Ethernet. Other forms of digital data bus are useful.

The image data may be for a region ahead of the vehicle. The image data may be obtained by the processing device from one or more image sensing means, such as cameras, associated with the vehicle. As will be explained in connection with FIG. 3, a camera may be mounted upon a front of the vehicle to view forwards there-from in a driving direction of the vehicle. Where the images concerned are to another side of the vehicle then clearly the camera position will be appropriately shifted. The camera may be arranged so as to obtain image data of the environment in front of the vehicle that is not obscured by the bonnet 205. As will be described in greater detail below, appropriate time shifting of the images as the vehicle moves forward allows for images corresponding to a view of the driver or a passenger without the bonnet 205 being present to be provided to the display means. That is, the display means may output image data that would be perceived by the driver if the bonnet 205 was not present i.e. not obstructing the driver's view.

As shown in FIG. 3, which illustrates a front portion of a vehicle 300 in side-view, a camera 310 may be mounted at a front of the vehicle lower than a plane of the bonnet 305, such as behind a grill of the vehicle 300. Alternatively, or in addition, a camera 320 may be positioned above the place of the bonnet 305, for instance at roof level or at an upper region of the vehicle's windscreen 360. The field of view of each camera may be generally forward and slightly downward to output image data for a portion of ground ahead of the vehicle's current location. Each camera outputs image data corresponding to a location ahead of the vehicle 300. It will be realised that the camera may be mounted in other locations, and may be moveably mounted to rotate about an axis such that a viewing angle of the camera is vertically controllable. A vertical position of the camera may also be controlled. The moveable camera may be arranged to view in a substantially constant horizontal axis regardless of an inclination of the vehicle. For example the camera may be arranged to view generally horizontally even when the vehicle is inclined. However it will be appreciated that the camera may be arranged to be oriented non-horizontally. The camera may be arranged to have a generally constant downward orientation so as to view, and provide image data corresponding to a region forward of the vehicle. When appropriately delayed, as will be described, the display means may display image data corresponding to a region forward of the vehicle which is obscured from the driver's view by the bonnet 205. The region may, for instance, be a region which is up to 10 or 20 m ahead of the vehicle.

The next step of the method for providing the improved view of FIG. 2 is to generate a graphical representation of at least one component of the vehicle having one or more characteristics based on the information associated with the vehicle, and a graphical representation of the image data. The representation, of at least one component and the image data, may be generated by a processing device. Alternatively, it may be that only the representation of at least one component or only the representation of the image data may be generated.

The representation, particularly of the image data although optionally also of the at least one component, may be generated so as to match, or correspond to, a perspective from a point to view of the driver. For example, an image processing operation may be performed on the image data to adjust a perspective of the image data. The perspective may be adjusted to match, or to be closer to, a perspective of a subject of the image data as viewed from the driver's position within the vehicle.

The image processing operation comprises a delay being introduced into the image data. The delay time may be based upon a speed of travel of the vehicle. The delay may allow the displayed representation based on the image data obtained from the camera to correspond to a current location of the vehicle. For example, if the image data is for a location around 20 m ahead of the vehicle the delay may allow the location of the vehicle to approach the location of the image data such that, when the representation is displayed, the location corresponding to the image data is that which is obscured from the passenger's view by the bonnet 205. In this way the displayed representation matches a current view of the driver. It will be appreciated that the delay may also be variable according to the driver's viewing position given that the driver's viewing position affects the portion of the roadway occluded by the bonnet 205. The image processing operation may be performed by the processing device.

Once generated, the representation is displayed. The representation is displayed so as to overlie a portion of the vehicle's body from the viewer's point of view, such as the driver's point of view. The method may be performed continually in a loop until a predetermined event occurs, such as a user interrupting the method, for example by activating a control within the vehicle. It will be realised that the predetermined event may be provided from other sources.

The representation may be displayed upon a display apparatus provided within the vehicle such that the displayed information overlies a portion of the vehicle under the control of a processing device. The processing device may be further arranged to determine information associated with a vehicle, or to receive image data for a region ahead of the vehicle, and to cause the display device to display a graphical representation of at least one component of the vehicle having one or more characteristics based on the information associated with the vehicle, or a representation of the image data. The information received by the processing device may include a steering angle of the vehicle's wheels, or image data output by one or more cameras. The information or image data may be received by the processing device from a communication bus of the vehicle, or via a dedicated communication channel such as a video feed from the one or more cameras.

The graphic representation generated by the processing device may be a representation of the vehicle's wheels as shown in FIG. 2, although the representation may be of other components of the vehicle such as a suspension system, axle of the vehicle, an engine of the vehicle, or any other generally mechanical component of the vehicle. The processing device may perform one or more image processing operations on the representation, such as altering a perspective of the image data and/or introducing a delay to the image data as described above. The perspective of the image data may be altered to match a viewing angle of the driver. The processing device may be arranged to receive image data corresponding to a view of the driver and to determine their viewing direction based thereon, such as based on the driver's eye position, or may receive data indicative of the driver's viewing direction from another sub-system of the vehicle. The image data may also be processed to adjust the representation to match a shape of the vehicle's body, for example to adjust for contours in the vehicle's bonnet shape.

The display device may comprises a projector for projecting light which is operably controlled by the processing device to project the representation by emitting light toward an optical combiner. The projection device and combiner together form a head-up display (HUD). When no light is being emitted by the projection device the combiner may be generally imperceptible to the driver of the vehicle, but when light is projected from the projection device and hits the combiner an image is viewed thereon by the passenger. The combiner is positioned such that an image viewed thereon by the driver appears to overlie a portion of the vehicle's body as the bonnet. That is the image appears above the bonnet. The displayed representation allows the driver to appreciate a location and direction of the vehicle's wheels and a position and direction of the roadway on which the vehicle is travelling, which is particularly useful for off-road driving. In addition to the representation of the wheel positions shown in FIG. 2, the HUD may display additional vehicle information, which might otherwise be presented to a driver through an alternative dashboard display, for instance vehicle speed.

For the improved forwards driver view described above in connection with FIGS. 2 and 3 an image is displayed to overlie an external portion of the vehicle. As noted previously, this concept is extensible to displaying an image derived from a camera capturing images of the environment surrounding a vehicle so as to also overlie at least a portion of an interior of the vehicle. As previously discussed, from the perspective of a driver a view external to the vehicle can be obscured by both the vehicle's body external to a passenger compartment of the vehicle, for instance the bonnet, and also by interior portions of the vehicle, such as the inside of a door. To address this broader problem, one or more further HUDs may be collocated with or incorporated into one or more vehicle windows other than the windscreen. Alternatively or in addition, an interior display means may provide an image interior to the vehicle for displaying one or both of image data and/or a representation of one or more components of the vehicle. The interior display means may comprise at least one projection device for projecting an image onto interior surfaces of the vehicle. The interior surfaces may comprise a dashboard or instrument panel, door interior or other interior surfaces of the vehicle. The projection device may be arranged in an elevated position within the vehicle to project the images downward onto the interior surfaces of the vehicle. The head-up display means and interior display means may be both communicatively coupled to a control device such as that illustrated in FIG. 5, which is arranged to divide image data for display there-between. By so doing, an image produced jointly between the head-up display means and interior display means provides a greater view of objects external to the vehicle. The view may be appreciated not only generally ahead of the driver, but also to a side of the driver or passenger when images are projected onto interior surfaces of the vehicle indicative of image data external to the vehicle and/or one or more components of the vehicle.

While the improved forwards view illustrated in FIG. 2 assists a driver to identify objects close to the front of the vehicle that are obscured by the bonnet, it is of no assistance once the objects have passed under the vehicle. According to embodiments of the present invention, now to be described, the problem of the driver being unable to view the terrain underneath a vehicle may be addressed through the use of historic (that is, time delayed) video footage obtained from a vehicle camera system, for instance the vehicle camera system illustrated in FIG. 3. A suitable vehicle camera system comprises one or more video cameras positioned upon a vehicle to capture video images of the environment surrounding the vehicle which may be displayed to aid the driver.

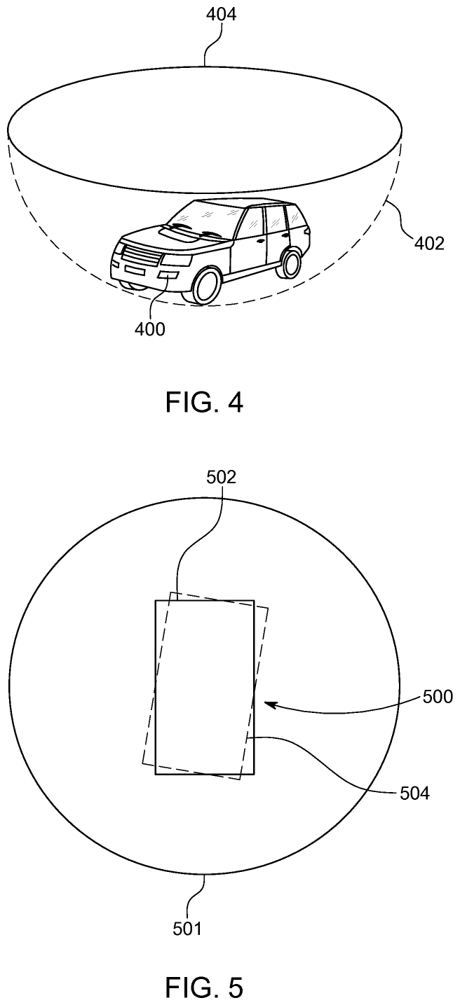

It is known to take video images (or still images) derived from multiple vehicle mounted cameras and form a composite image illustrating the environment surrounding the vehicle. Referring to FIG. 4, this schematically illustrates such a composite image surrounding a vehicle 400. Specifically, the multiple images may be combined to form a 3-Dimensional (3D) composite image that may, for instance, be generally hemispherical as illustrated by outline 402. This combination of images may be referred to as stitching. The images may be still images or may be live video images. The composite image is formed by mapping the images obtained from each camera onto an appropriate portion of the hemisphere. Given a sufficient number of cameras, and their appropriate placement upon the vehicle to ensure appropriate fields of view, it will be appreciated that the composite image may thus extend all around the vehicle and from the bottom edge of the vehicle on all sides up to a predetermined horizon level illustrated by the top edge 404 of hemisphere 402. It will be appreciated that it is not essential that the composite image extends all of the way around the vehicle. For instance, in some circumstances it may be desirable to stitch only camera images projecting generally in the direction of motion of the vehicle and to either side—directions where the vehicle may be driven. This hemispherical composite image may be referred to as a bowl. Of course, the composite image may not be mapped to an exact hemisphere as the images making up the composite may extend higher or lower, or indeed over the top of the vehicle to form substantially a composite image sphere. It will be appreciated that the images may alternatively be mapped to any 3D shape surrounding the vehicle, for instance a cube, cylinder or more complex geometrical shape, which may be determined by the number and position of the cameras. It will appreciate that the extent of the composite image is determined by the number of cameras and their camera angles. The composite image may be formed by appropriately scaling and/or stretching the images derived from each camera to fit to one another without leaving gaps (though in some cases gaps may be left where the captured images do not encompass a 360 degree view around the vehicle).

The composite image may be displayed to the user according to any suitable display means, for instance the Head-Up Display, projection systems or dashboard mounted display systems described above. While it may be desirable to display at least a portion of the 3D composite image viewed for instance from an internal position in a selected viewing direction, optionally a 2-Dimensional (2D) representation of a portions of the 3D composite image may be displayed. According to certain other embodiments it may be that a composite 3D image is never formed—the video images derived from the cameras being mapped only to a 2D plan view of the environment surrounding the vehicle. This may be a side view extending from the vehicle, or a plan view such as is shown in FIG. 5.

FIG. 5 shows a composite image 500 giving a bird's eye view of the environment surrounding a vehicle 502, also referred to as a plan view. Such a plan view may be readily displayed upon a conventional display screen mounted inside the vehicle and provides useful information to the driver concerning the environment surrounding the vehicle 502 extending up close to the sides of the vehicle. As discussed above, from the driving position it may be difficult or even impossible to see the ground immediately adjacent to the vehicle and so the plan view of FIG. 5 is a significant aid to the driver. The ground underneath the vehicle remains obscured from a camera live view and so may typically be represented in the composite image 500 by a blank region 502 at the position of the vehicle, or a representation of a vehicle to fill the blank. Without providing cameras underneath the vehicle, which is undesirable as discussed above, for a composite image formed solely from stitched live camera images the ground underneath the vehicle cannot be seen.

According to embodiments of the present invention, in addition to the cameras being used to provide a composite live image of the environment surrounding the vehicle, historic images may be incorporated into the composite image to provide imagery representing the terrain under the vehicle—that is, the terrain within the boundary of the vehicle. By historic images, it is meant images that were captured previously by the vehicle camera system, for instance images of the ground in front of or behind the vehicle; the vehicle subsequently having driven over that portion of the ground. The historic images may be still images or video images or frames from video images. Such historic images may be used to fill the blank region 502 in FIG. 5. It will be appreciated that particularly for off-road situations the ability to see the terrain in the area under the vehicle (strictly, a representation of the terrain derived from historic images captured before the vehicle obscured the terrain) allows the driver to perform fine adjustment of the vehicle position and in particular the vehicle wheels. As for the improved view of FIG. 2, in addition to this composite image formed from live and historic video imagery, representations of vehicle systems or components, for instance the wheel positions, may also be incorporated into the composite image. The above description in relation to FIG. 2 regarding the obtaining of information about vehicle systems and the generation of representations of such vehicle systems should be considered to apply equally to the discussion of a composite image below.

The composite image may be formed by combining the live and historic video images, and in particular by performing pattern matching to fit the historic images to the live images thereby filling the blank region in the composite image comprising the area under the vehicle. The surround camera system comprises at least one camera and a buffer arranged to buffer images as the vehicle progresses along a path. The vehicle path may be determined by any suitable means, including but not limited to a satellite positioning system such as GPS (Global Positioning System), IMU (Inertial Measurement Unit), wheel ticks (tracking rotation of the wheels, combined with knowledge of the wheel circumference) and image processing to determine movement according to shifting of images between frames. At locations where the blank region from the live images overlaps with buffered images, the area of the blank region copied from delayed video images is pattern matched through image processing to be combined with the live camera images forming the remainder of the composite image.

Advantageously, embodiments the present invention provide a method for displaying the position of all wheels of a vehicle and the whole vehicle floor clearance combined with live images of the environment surrounding the vehicle. This provides for improved driver information to allow them to progress safely and confidently, particularly when travelling through rough terrain. The use of pattern matching provides particular improvements in the combining of live and historic images.

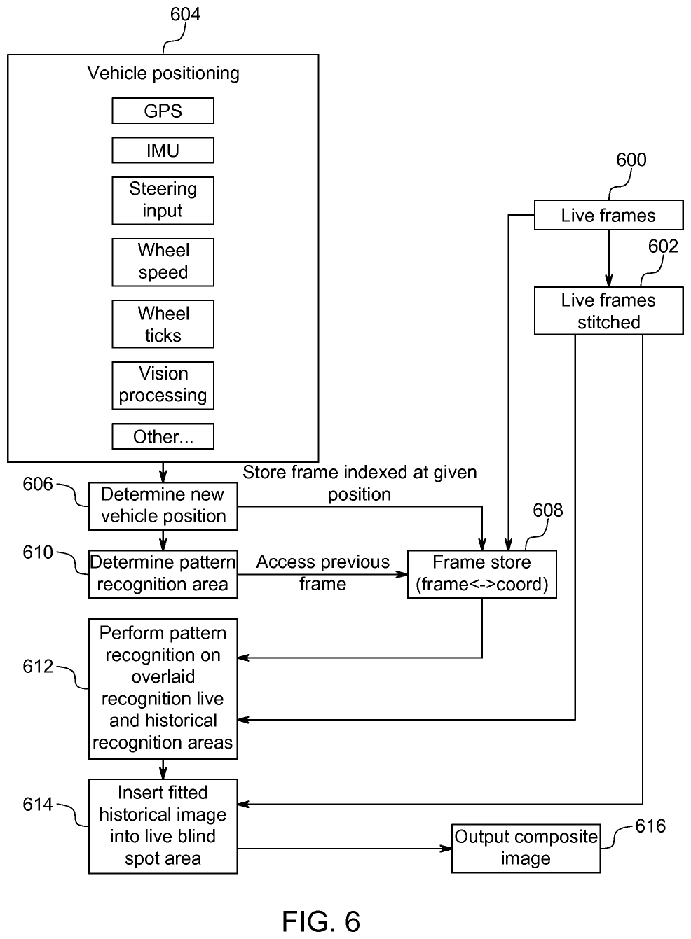

Referring now to FIG. 6, this illustrates a method of forming a composite image from live video images and historic video images according to an embodiment of the present invention. At step 600 live video frames are obtained from the vehicle camera system. The image data may be provided from one or more cameras outwards from the vehicle, as previously explained. In particular, one or more cameras may be arranged to view in a generally downward direction in front of or behind the vehicle at a viewing point a predetermined distance ahead of the vehicle. It will be appreciated that such cameras may be suitably positioned to capture images of portions of the ground which may later be obscured by the vehicle.

At step 602 the live frames are stitched together to form the composite 3D image (for instance, the image “bowl” described above in connection with FIG. 4) or a composite 2D image. Suitable techniques for so combining video images will be known to the skilled person. It will be understood that the composite image may be formed continuously according to the 3D images or processed on a frame-by-frame basis. Each frame, or perhaps only a portion of the frames such as every n^{th} frame for at least some of the cameras, is stored for use in fitting historical images into a blank region of the composite image currently displayed (this may be referred to as a live blind spot area or blank region). For instance, where the bird's eye view composite image 500 of FIG. 5 is displayed on a screen, the live blind spot area is blank region 502.

According to certain embodiments, to constrain the image storage requirements, only video frames from cameras facing generally forwards (or forwards and backwards) may be stored as it is only necessary to save images of the ground in front of the vehicle (or in front and behind) that the vehicle may subsequently drive over in order to supply historic images for inserting into the live blind spot area. To further reduce the storage requirements it may be that not the whole of every image frame is stored. For a sufficiently fast stored frame rate (or slow driving speed) there may be considerable overlap between consecutive frames (or intermittent frames determined for storage if only every n^{th} frame is to be stored) and so only an image portion differing from one frame for storage to the next may be stored, together with sufficient information to combine that portion with the preceding frame. Such an image portion may be referred to as a sliver or image sliver. It will be appreciated that other than an initially stored frame, every stored frame may require only a sliver to be stored. It may be desirable to periodically store a whole frame image to mitigate the risk of processing errors preventing image frames from being recreated from stored image slivers. This identification of areas of overlap between images may be performed by suitable known image processing techniques that may include pattern matching—that is, matching image portion of images common to a pair of frames to be stored. For instance, pattern matching may use known image processing algorithms for detecting edge features in images, which may therefore suitably identify the outline of objects in images, those outlines being identified in a pair of images to determine the degree of image shift between the pair due to vehicle movement.

Each stored frame, or stored partial frame (or image sliver) is stored in combination with vehicle position information. Therefore, in parallel to the capturing of live images at step 600 and the live image stitching at step 602, at step 604 vehicle position information is received. The vehicle position information is used to determine the vehicle location at step 606. The vehicle position may be expressed as a coordinate, for instance a Cartesian coordinate giving X, Y and Z positions. The vehicle position may be absolute or may be relative to a predetermined point. The vehicle position information may be obtained from any suitable known positioning sensor, for instance GPS, IMU, knowledge of the vehicle steering position and wheel speed, wheel ticks (that is, information about wheel revolutions), vision processing or any other suitable technique. As will be appreciated, use of data from GPS and inertial measurement equipment will provide useful information to the system as to the direction of the vehicle travel, vehicle orientation/attitude relative to the prevailing terrain and road roughness, all of which can be used to match the image being presented on the display to the driver with the current scene, compensating for any obscuration caused by the vehicle. Vision processing may comprise processing images derived from the vehicle camera systems to determine the degree of overlap between captured frames, suitably processed to determine a distance moved through knowledge of the time between the capturing of each frame. This may be combined with the image processing for storing captured frames as described above, for instance pattern matching including edge detection. In some instances it may be desirable to calculate a vector indicating movement of the vehicle as well as the vehicle position, to aid in determining the historic images to be inserted into the live blank region area, as described below.

Each frame that is to be stored (or sliver), from step 600, is stored in a frame store at step 608 along with the vehicle position obtained from step 606 at the time of image capture. That is, each frame is stored indexed by a vehicle position. The position may be an absolute position or relative to a reference datum. Furthermore, the position of image may be given relative only to a preceding stored frame allowing the position of the vehicle in respect of each historic frame to be determined relative to a current position of the vehicle by stepping backwards through the frame store and noting the shift in vehicle position until the desired historic frame is reached. Each record in the frame store may comprise image data for that frame (or image sliver) and the vehicle position at the time the frame was capture. That is, along with the image data, metadata may be stored including the vehicle position. The viewing angle of the frame relative to the vehicle position is known from the camera position and angle relative to the vehicle (which as discussed above may be fixed or moveable). Such information concerning the viewing angle, camera position etc. may also be stored in frame store 608, which is shown representing the image and coordinate information as (frame <->co-ord). It will be appreciated that there may be significant variation in the format in which such information is stored and the present invention is not limited to any particular image data or metadata storage technique, nor to the particulars of the position information that is stored.

At step 610 a pattern recognition area is determined. The pattern recognition area comprises the area under the vehicle that can't be seen in the composite image formed solely from stitched live images. Referring back to FIG. 5, the pattern recognition area comprises the blank region 502. Coordinates for the pattern recognition area can be determined from the vehicle positioning information obtained at step 604 and as processed to determine the current vehicle position at step 606. Assuming highly accurate vehicle position information obtained at step 604, it will be appreciated that the current position of the vehicle may be exactly determined. Historic image data from frame store 608, that is, previously captured image frames, may be used to fill in blank region 502 based on knowledge of the vehicle position at the time the historic images were captured. Specifically, the current blind spot may be mapped to an area of ground which is visible in historic images captured before the vehicle obscured that portion of the ground. The historic image data may be used through knowledge of the area of ground in the environment surrounding the vehicle in each camera image, as a result of the position of each camera upon the vehicle and the camera angle being known. As such, if the current vehicle position is known, image data showing the ground in the blank region may be obtained from images captured at an earlier point in time before the vehicle obscures that portion of ground. Such image data may be suitably processed to fit the current blank region and inserted into the stitched live frames. Such processing may include scaling and stretching the stored image data to account for a change in perspective from the outward looking camera angle to how the ground would appear if viewed directly from above. Additionally, such processing may include recombining multiple stored image slivers and/or images from multiple cameras.

However, the above described fitting of previous stored image data into a live stitched composite image is predicated on exact knowledge of the vehicle position both currently and when the image data is stored. It may be the case that it is not possible to determine the vehicle position to a sufficiently high degree of accuracy. As an example, with reference to FIG. 5, the true current vehicle position is represented by box 502, whereas due to inaccurate position information the current vehicle position determined at step 606 may be represented by box 504. In the example of FIG. 5 the inaccuracy comprises the determined vehicle position being rotated relative to the true vehicle position. Equally, translational errors may occur. Errors in calculating the vehicle position may arise due to the vehicle wheels sliding, where wheel ticks, wheel speed and/or steering input are used to determine relative changes in vehicle position. Where satellite positioning is used it may be the case that the required level of accuracy is not available.

It will be appreciated that where the degree of error in the vehicle position differs between the time at which an image is stored and the time at which it is fitted into a live composite image this may cause undesirable misalignment of the live and historic images. This may cause a driver to lose confidence in the accuracy of the representation of the ground under the vehicle. Worse still, if the misalignment is significant then there may be a risk of damage to the vehicle due to a driver being misinformed about the location of objects under the vehicle.

Due to risk of misalignment, at step 612 pattern matching is performed within the pattern recognition area to match regions of live and stored images. As noted above in connection with storing image frames, such pattern matching may include suitable edge detection algorithms. The determined pattern recognition region at step 610 is used to access stored images from the frame store 608. Specifically, historic images containing image data for the ground within the pattern recognition area is retrieved. The pattern recognition area may comprise the expected vehicle blank region and a suitable amount of overlap on at least one side to account for misalignment. Step 612 further takes as an input the live stitched composite image from step 602. The pattern recognition area may encompass portions of the live composite view adjacent to the blank region 502. Pattern matching is performed to find overlapping portions of the live and historic images, such that close alignment between the two can be determined and used to select appropriate portions of the historic images to fill the blank region. It will be appreciated that the amount of overlap between the live and historic images may be selected to allow for a predetermined degree of error between the determined vehicle position and its actual position. Additionally, to take account of possible changes in vehicle pitch, roll and yaw between a current position and a historic position as a vehicle traverses undulating and/or slippery terrain, the determination of the pattern recognition region may take account of information from sensor data indicating the vehicle pitch, roll and yaw. This may affect the degree of overlap of the pattern recognition area with the live images for one or more sides of the vehicle. It will be appreciated that according to some embodiments it may not be necessary to determine a pattern recognition area, rather the pattern matching may comprise a more exhaustive search through historic images (or historic images with an approximate time delay relative to the current images) relative to the whole composite live image. However, by constraining the region within the live composite image within which pattern matching to historic images is to be performed, and constraining the volume of historic images to be matched, the computational complexity of the task and the time taken may be reduced.

At step 614 selected portions of one or more historic images or slivers are inserted into the blank region in the composite live images to form a composite image encompassing both live and historic images. As for the discussion above in connection with FIG. 2, the composite image may be further combined with graphical representations of one or vehicle component or system. For instance, a representation of the location and orientation of at least one, for instance all of, the wheels may be overlaid upon the composite image to provide the driver with further information concerning the alignment of the vehicle to aid in avoiding objects. The generation of such representations of vehicle components is as described above and will not be repeated here.

Furthermore, in addition to displaying a representation of the ground under the vehicle, according to certain embodiments of the invention a representation of the vehicle may be added to the output composite image. For instance, a translucent vehicle image or an outline of the vehicle may be added. This may assist a driver in recognising the position of the vehicle and the portion of the image representing the ground under the vehicle.

In some embodiments, where the composite image is to be displayed overlying portions of the vehicle to give the impression of the vehicle being transparent or translucent (for instance using a HUD or a projection means as described above), the generation of a composite image may also require that a viewing direction of a driver of the vehicle is determined. For instance, a camera is arranged to provide image data of the driver from which the viewing direction of the driver is determined. The viewing direction may be determined from an eye position of the driver, performed in parallel to the other steps of the method. It will be appreciated that where the composite image or a portion of the composite image is to be presented on a display in the vehicle which is not intended to show the vehicle being see-through, there is no need to determine the driver's viewing direction.

The combined composite image is output at step 616. As discussed above, the composite image output may be upon any suitable image display device, such as HUD, dashboard mounted display screen or a separate display device carried by the driver. Alternatively, portions of the composite image may be projected onto portions of the interior of the vehicle to give the impression of the vehicle being transparent or translucent. The present invention is not limited to any particular type of display technology.

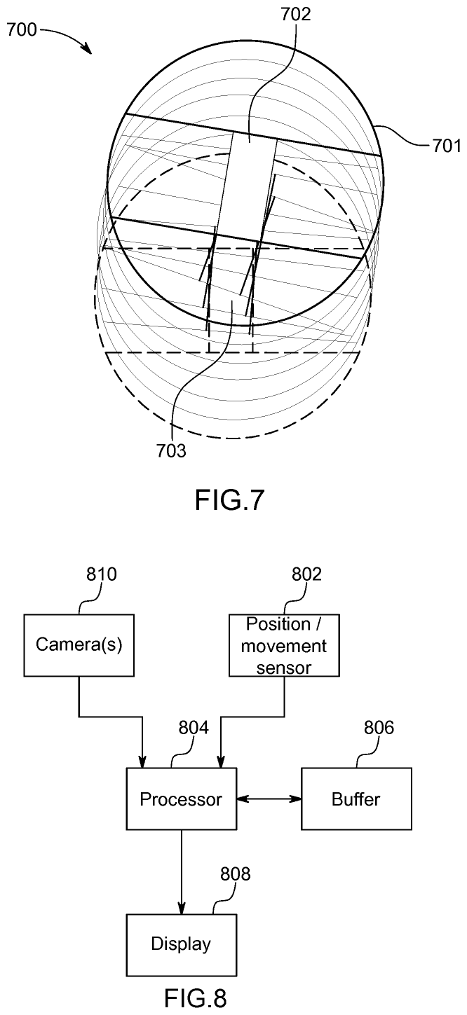

Referring now to FIG. 7, this illustrates the progression composites of live and historic images 700 as a vehicle 702 moves. In the example of FIG. 7 the composite image is represented as a bird eye view above the vehicle and encompassing an 11 m bowl surrounding the vehicle, with the blank region under the vehicle being filled with historic images. FIG. 7 shows the composite image tracking the vehicle location as it turns first right and then left (travelling from bottom to top in the view of FIG. 7), with the outline of each composite image being shown in outline. The current location of the vehicle is shown shaded. As noted above, the present invention is not limited to the presentation to the driver of a composite plan view of the car, its surroundings and the ground under the car. A 3D representation could be provided or any 2D representation derived from any portion of a 3D model, for instance that shown in FIG. 4, and viewed from any angle internal or external to the vehicle.

FIG. 8 illustrates an apparatus suitable for implementing the method of FIG. 6. The apparatus may be entirely contained within a vehicle. One or more vehicle mounted camera 800 (for instance, that of FIG. 3) captures image frames used to form a live portion of a composite image or a historic portion of a composite image, or both. It will be appreciated that according to some embodiments of the invention separate cameras may be used to supply live and historic images or their roles may be combined. One or more position or movement sensor 802 may be used to sense the position of the vehicle or movement of the vehicle. At least one camera 800 and at least one sensor 802 supply data to processor 804 and are under the control of processor 804. Processor 804 buffers images from camera 800 in buffer 806. Processor 804 further acts to generate a composite image including live images received from camera 800 and historic images from buffer 806. The processor 804 controls display 808 to display the composite image. It will be appreciated that apparatus of FIG. 8 may be incorporated within the vehicle of FIG. 3, in which case camera 800 may be provided by one or more of cameras 310, 320. Display 808 is typically located in the vehicle cabin and may take the form of a dashboard mounted display, or any other suitable type, as described above. The scope of the present invention does not exclude some portion of the image processing being performed by systems external to the vehicle.

It will be appreciated that embodiments of the present invention can be realised in the form of hardware, software or a combination of hardware and software. In particular, the method of FIG. 6 may be implemented in hardware and/or software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A display method for use in a vehicle, the method comprising:
capturing images of a region external to the vehicle;
storing at least a portion of the captured images;
generating a composite image from a current image and a stored image by matching portions of the stored image and the current image; and
displaying at least part of the composite image;
wherein the composite image comprises a first region generated from the current image and a second region generated from the stored image, the second region not being visible within the current image.

2. A display method according to claim 1, wherein the composite image comprises a 3-Dimensional (3D) representation or a 2-Dimensional (2D) representation of the environment surrounding the vehicle and extending at least partially underneath the vehicle.

3. A display method according to claim 2, wherein displaying at least part of the composite image comprises generating a 2D representation of at least a portion of the 3D representation and displaying the 2D representation.

4. A display method according to claim 1, wherein the captured image data comprises a series of image frames; and wherein the method further comprises:
determining a position of the vehicle; and
storing an indication of the position of the vehicle with at least a portion of an image frame.

5. A display method according to claim 1, wherein matching portions of the stored image and the current image comprises matching overlapping portions of the stored image and the current image.

6. A display method according to claim 1, wherein matching portions of the stored image and the current image comprises performing pattern matching to identify features present in both the stored image and the current image such those features are correlated in the composite image.

7. A display method according to claim 5, further comprising:
determining a pattern recognition region including an area which is not visible within the current image; and
determining a stored image including image data for the environment within the pattern recognition area.

8. A display method according to claim 7, wherein determining a pattern recognition region comprises determining coordinates for the pattern recognition region according to a current position of the vehicle.

9. A display method according to claim 8, wherein determining a pattern recognition region further includes receiving a signal indicating an orientation of the vehicle and adjusting the pattern recognition region coordinates according to the vehicle orientation.

10. A display method according to claim 1, wherein storing at least a portion of the captured image comprises:
storing a first captured image frame;
determining a degree of overlap between the first captured image frame and a second captured image frame; and
for the second captured image frame storing a non-overlapping portion of the second image frame.

11. A display method according to claim 1, wherein the composite image includes image data from multiple current images representing different views from the vehicle and at least one stored image such that the composite image comprises a contiguous view of at least a portion of the environment surrounding the vehicle and extending underneath the vehicle.

12. A display method according to claim 1, further comprising obtaining information associated with the vehicle and displaying a graphical representation of at least one component of the vehicle within the composite image.

13. A display method according to claim 12, wherein the information associated with the vehicle is information associated with the at least one component of the vehicle, the at least one component of the vehicle comprising at least one selected from a group consisting of:
a steering system of the vehicle;
one or more wheels of the vehicle;
a suspension of the vehicle or an engine of the vehicle; and
a further mechanical component of the vehicle.

14. A display method according to claim 1, wherein the composite image is displayed to overlie a portion of the vehicle to be indicative of a portion of the vehicle being at least partly transparent.

15. A display method according to claim 1, wherein the composite image is displayed to be translucent or overlies an internal or external vehicle portion.

16. A display method according to claim 1, wherein the image data is obtained from one or more cameras associated with the vehicle and arranged to capture images of the environment surrounding the vehicle.

17. A computer program product storing computer program code which is arranged when executed to implement the method of claim 1.

18. A display apparatus for use with a vehicle, comprising:
image capture means arranged to capture images of a region external to the vehicle;
a display means arranged to display information;
a storage means arranged to store at least a portion of the captured images; and
a processing means arranged to:
receive a current image from the image capture means;
cause the storage means to store at least a portion of the captured images;
generate a composite image from a current image and a stored image by matching portions of stored image and current image; and
cause the display means to display at least part of the composite image;
wherein the composite image comprises a first region generated from the current image and a second region generated from the stored image, the second region not being visible within the current image.

19. (canceled)

20. A vehicle comprising the display apparatus of claim 18.

21. (canceled)
